(19) United States
(12) Patent Application Publication
(10) Pub. No.: US 2009/0141682 A1
(43) Pub. Date: Jun. 4, 2009

(54) METHOD AND APPARATUS TO CONTROL AUDIO SWITCH DURING CALL HANDOFF

(75) Inventors: WEI ZOU, PALATINE, IL (US); ROBERT A. CORDES, SAN DIEGO, CA (US); XIANG-MING LI, NANJING (CN); JERRY J. MAHLER, HOFFMAN ESTATES, IL (US); YINGCHUNG XU, VERNON HILLS, IL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/948,219

(22) Filed: Nov. 30, 2007

(51) Int. Cl. H04Q 7/00

(52) U.S. Cl. 370/331

(57) ABSTRACT

A method and system of controlling an audio switch at a receiving unit during handoff is disclosed herein. The method can include the step of—at a receiving unit with an audio call active on a first network supporting a first audio protocol—setting up a second audio call on a second network supporting a different audio protocol. The method can further include the steps of monitoring for one or more events, detecting one or more of the events, and in response to the detection of one or more of the events, switching an audio path of the receiving unit from the first network to the second network.

### BACKGROUND OF THE INVENTION

1. Field of the Invention

The claimed subject matter concerns handoff of audio calls from one network to another, and more particularly, methods for switching the audio path at a handset during such a handoff.

2. Description of the Related Art

As wireless protocols continue to evolve, users will expect near ubiquitous coverage for both voice and data applications. To provide the users with such coverage, handset manufacturers can offer multi-mode devices that are capable of communicating with and switching between several networks, which may support different radio technologies. For example, if a user making a call on a first network leaves the coverage area of the network, the call can be handed off to a second network in which the user is within coverage. The effective coverage for a multi-mode device, therefore, is greater than the coverage provided to a device that is only capable of communicating with the first network.

In existing data protocols, the receiving device continues to request retransmission of corrupt or lost packets, both before and after a handoff is made. All packets will eventually arrive at the device, perhaps after some delay, but such a delay may be imperceptible to the user of the device. In contrast, real-time audio traffic is very sensitive to such a delay, and the handoff between networks can result in a noticeable audio gap heard by the user if the audio path is not switched properly. For example, if a voice call on a first network is handed off to a second network, the first network or the second network can control the moment to switch the audio path and can notify the receiving device to switch the audio path from the first network to the second network. However, the audio switch of the controlling network and the audio switch of the receiving device are typically unsynchronized, which may cause a noticeable audio gap during the handoff. To minimize the degradation to audio quality as a result of handoff between networks, an efficient mechanism for switching the audio path between networks is needed.

### SUMMARY OF THE INVENTION

A method and system of controlling an audio switch at a receiving unit during handoff is described herein. The method can include the step of—at a receiving unit with an audio call active on a first network supporting a first audio protocol—setting up a second audio call on a second network supporting a different audio protocol. The method can also include the steps of monitoring for one or more events, detecting one or more of the events, and—in response to the detection of one or more of the events—switching an audio path of the receiving unit from the first network to the second network.

The events can include (1) receiving at the receiving unit a termination message from the first network; (2) the receiving unit detecting audio content on the second network; (3) the receiving unit not detecting audio content on the first network; or (4) the receiving unit losing association with the first network. Losing association can include the step of the receiving unit not receiving a probe signal from the first network during a window of time.

In one embodiment, the first network can be a Wi-Fi network, and the second network can be a CDMA network. In another embodiment, the first network can be a CDMA network, and the second network can be a Wi-Fi network.

A receiving unit capable of controlling an audio switch during handoff is also described herein. The receiving unit can include a transceiver that is capable of receiving wireless signals from a first network and a second, different network. The receiving unit can also include a processor coupled to the transceiver. The processor can be operable to support an audio call on the first network in which the first network supports a first audio protocol, and to set up another audio call on the second network in which the second network supports a different audio protocol. The processor can be further operable to monitor for one or more events, detect one or more of the events, and—in response to the detection of one or more of the events—perform an audio switch to enable the receiving unit to handoff from the first network to the second network.

A machine readable storage device, having stored thereon a computer program having a plurality of code sections executable by a portable receiving device for controlling the audio switch during handoff, is also described herein. Execution of the code sections can cause the receiving device to perform the steps of activating an audio call on a first network supporting a first audio protocol and setting up a second audio call on a second network supporting a different audio protocol. Execution of the code sections can further cause the receiving unit to perform the steps of monitoring for one or more events, detecting one or more of the events, and—in response to the detection of one or more of the events—switching an audio path of the receiving device from the first network to the second network.

### BRIEF DESCRIPTION OF THE DRAWINGS

Features that are believed to be novel are set forth with particularity in the appended claims. The claimed subject matter may best be understood by reference to the following description, taken in conjunction with the accompanying drawings, in the several figures of which like reference numerals identify like elements, and in which:

FIG. 1 illustrates an example of a first and second network and a receiving unit that can communicate with the networks;

FIG. 2 shows an example of a block diagram of a base station of a communication network and a block diagram of a receiving unit; and

FIG. 3 illustrates an example of a method of controlling an audio switch at a receiving unit during handoff.

### DETAILED DESCRIPTION

As required, detailed embodiments of the claimed subject matter are disclosed herein; however, it is to be understood that the disclosed embodiments are merely exemplary and can be embodied in various forms. Therefore, specific structural and functional details disclosed herein are not to be interpreted as limiting, but merely as a basis for the claims and as a representative basis for teaching one skilled in the art to variously employ the claimed subject matter in virtually any appropriately detailed structure. Further, the terms and phrases used herein are not intended to be limiting but rather to provide an understandable description.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled” as used herein, is defined as connected, although not necessarily directly, and not necessarily mechanically.

The term “transceiver” can be defined as any component or group of components that is capable of at least receiving communications signals, including groups of components that are capable of at least simultaneously receiving communication signals from different sources that can support different protocols, in which the source can be a network or a receiving unit. The term “processor” can mean any component or group of components, including any suitable combination of hardware and software, that is capable of carrying out any of the processes described herein.

The term “event” can refer to an occurrence or to a condition that may cause a receiving unit to switch from a first network to a second network. The term “monitor” can mean periodically checking one or more communication channels for one or more events. A “handoff” can be a process in which a receiving unit receiving signals from a first network during a communication session subsequently receives signals from a second, different network during the same communication session.

An “audio signal” can be a wireless signal that represents audio content. The term “audio protocol” can refer to a set of pre-determined rules used by two units to exchange audio signals. An “audio call” can be a communication session wherein a receiving unit at least receives an audio signal using an audio protocol. Each of the terms “audio switch” and “switching an audio path” can refer to a process in which a receiving unit that has designated a first audio signal from a first network for audible playout at the receiving unit designates or selects a second, different audio signal from a second, different network for audible playout at the receiving unit.

A method and system of controlling an audio switch at a receiving unit during handoff is disclosed herein. The method can include the step of—at a receiving unit with an audio call active on a first network supporting a first audio protocol—setting up a second audio call on a second network supporting a different audio protocol. The method can further include the steps of monitoring for one or more events, detecting one or more of the events, and in response to the detection of one or more of the events, switching an audio path of the receiving unit from the first network to the second network.

The events can include (1) receiving at the receiving unit a termination message from the first network; (2) the receiving unit detecting audio content on the second network; (3) the receiving unit not detecting audio content on the first network; or (4) the receiving unit losing association with the first network. The method allows a receiving unit to make an efficient switch of the audio path from a first network to a second network during an audio call, which will eliminate audio gaps that may disrupt a user's call.

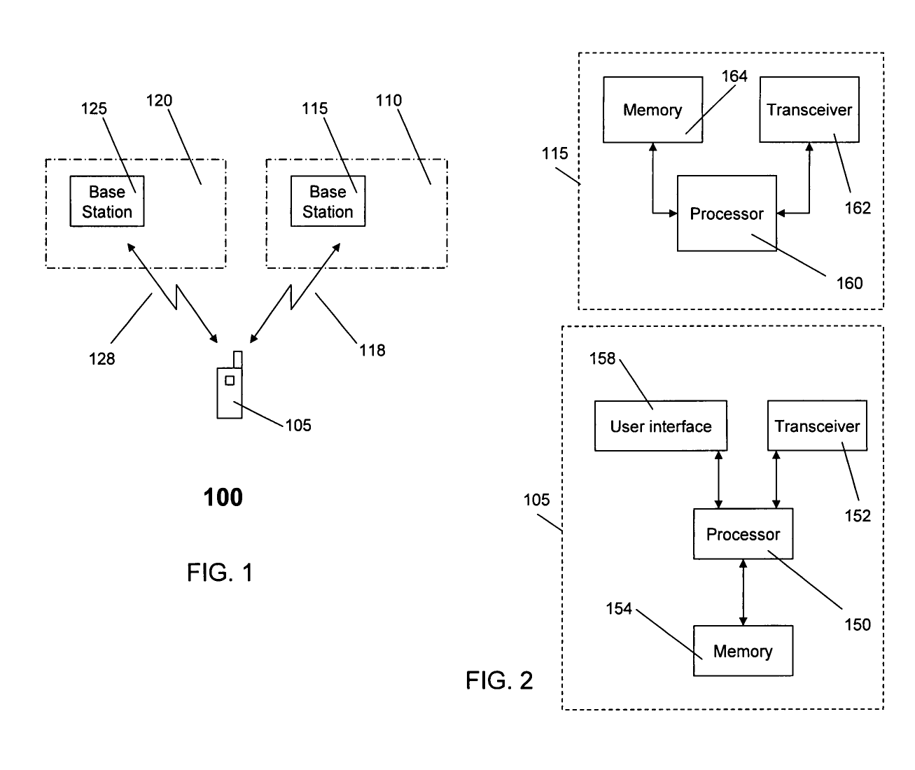

Referring to FIG. 1, a system 100 can include a first communication network 110 and a second communication network 120. The first network 110 can include one or more base stations 115 that can communicate with one or more receiving units 105 over a wireless channel 118. Similarly, the second network 120 can include one or more base stations 125 that can communicate with one or more receiving units 105 over a wireless channel 128. In one arrangement, the first network 110 can support a first audio protocol, and the second network 120 can support a second, different audio protocol.

The receiving unit 105 can be operable to communicate simultaneously with the first network 110 over the wireless channel 118 and the second network 120 over the wireless channel 128. The receiving unit 105 can be further operable to support an audio protocol supported by the first network 110 and an audio protocol supported by the second network 120. As will be explained below, while the receiving unit 105 is engaged in a first audio call with the first network 110, the receiving unit 105 and the second network 120 can begin and engage in a second audio call.

As an example, the first network 110 can be a Wi-Fi network and the second network 120 can be a CDMA network, though one skilled in the art will recognize that each of the networks 110 and 120 can support Wi-Fi, CDMA, or any other suitable communication protocol. Furthermore, although the process described above is conducted over a network, those of skill in the art will appreciate that this idea could be implemented in a systemless, asynchronous communication environment.

Referring to FIG. 2, an example of the receiving unit 105 and a base station 115 are shown. In one arrangement, the receiving unit 105 can include a processor 150, a transceiver 152, a memory 154, and a user interface 158. As an option, the transceiver 152 can include groups of components that are capable of at least simultaneously receiving communication signals from different networks that can support different protocols. The memory 154 may be a part of the processor 150 or may be a separate unit under the control of the processor 150. The user interface 158 and the transceiver 152 can both be coupled to and under the control of the processor 150. As an example, the user interface 158 may include a display, a speaker, a keypad, or a vibration mechanism, although other suitable components may be part of the user interface 158. In an optional embodiment, the user interface 158 can be operable to give a visible, audible, or haptic indication to a user of the receiving unit 105 in response to an audio switch.

In another arrangement, the base station 115 may include a transceiver 162, a memory 164 and a processor 160, which may be coupled to both the transceiver 162 and the memory 164. As an option, the transceiver 162 can include groups of components that are capable of at least simultaneously receiving communication signals from different receiving units that can support different protocols. In addition, the memory 164 may be a part of the processor 160 or may be a separate unit under the control of the processor 160. It should be understood that this arrangement can be an example of the base station 115 of the first network 110 or the base station 125 of the second network 120. A description of the operation of these components will be presented below.

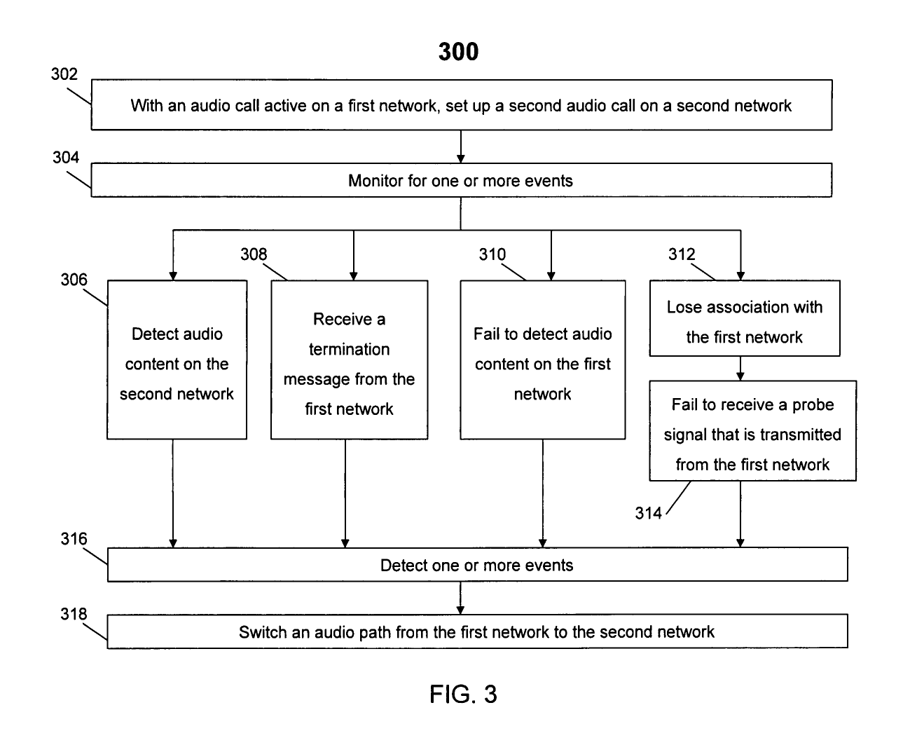

Referring to FIG. 3, a method 300 of performing an audio switch is shown. To describe this method 300, reference will be made to FIGS. 1 and 2, although it is understood that the method 300 can be practiced in any other suitable system using any other suitable components. Moreover, the steps of the method 300 are not limited to the particular order in which they are presented in the figure. Also, the method 300 can have a greater number of steps or a fewer number of steps than those shown in the figure.

At step 302, at a receiving unit with an audio call active on a first network supporting a first audio protocol, a second audio call can be set up on a second, different network supporting a second audio protocol. At step 304, monitoring for one or more events can occur. Following step 304, there are at least four optional steps, although these are not necessarily the only optional steps available. As an example, at step 306, audio content can be detected on the second network, or at step 308, a termination message can be received from the first network. As another example, at step 310, failure to detect audio content on the first network can occur, or at step 312, association with the first network can be lost. In particular, at step 314, failure to receive a probe signal from the first network during a window of time can occur, which may indicate that association with the first network has been lost. In step 316, one or more events can be detected, and in step 318, an audio path can be switched from the first network to the second network.

For example, referring to FIGS. 1 and 2, at a receiving unit 105 with an audio call active on a first network 110, a second audio call on a second network 120 can be set up. In one arrangement, the audio content received at the receiving unit 105 during an audio call can be voice content. In one embodiment, the second audio call can be set up in response to a request by the user of the receiving unit 105 through the user interface 158. For example, a user engaged in an audio call on the first network 110 may desire to switch the call to the second network 120, on which the price of an audio call is less expensive than on the first network. The user can manually instruct the receiving unit 105 to set up an audio call on the second network 120 through menu options on the user interface 158.

In an alternative embodiment, the second audio call can be set up at the direction of the processor 150 of the receiving unit 105, based on a predetermined set of rules stored in the memory 154. For example, a service contract of a user may designate that when the user engages in an audio call, the user preferably engages in the audio call on the second network 120 if the receiving unit 105 is within coverage of the second network 120. If the receiving unit 105 is not within coverage of the second network 120 and is engaged in an audio call with the first network 110, the processor 150 may be operable to periodically check if the user is within coverage of the second network 120, and to set up an audio call on the second network 120 in response. As another example, the processor 160 of the base station 125 may be operable to perform similar steps.

In another embodiment, the second audio call can be set up at the direction of the processor 150 of the receiving unit 105, based on conditions of one or more networks. For example, if the loading of the first network is higher than a predetermined threshold, the processor 150 may be operable to periodically check if the user is within coverage of the second network 120, and to set up an audio call on the second network 120 in response.

Once the second audio call has been set up on the second network 120, the receiving unit 105 can monitor for one or more events. This monitoring can include receiving wireless signals at the transceiver 152, processing the signals at the processor 150, or storing information to the memory 154. As an example of monitoring for an event, the receiving unit 105 can detect audio content on the second network 120. The detection of audio content can include the steps of receiving a wireless signal at the transceiver 152, processing the signal with the processor 150 to extract control information, and determining from the control information that the wireless signal contains audio content. For example, the control information can include a header field, and the header field can specify a call type, which can indicate that the signal contains audio content. Furthermore, the header field in the previous example can include a current service option, which can indicate that the signal contains audio content, as is known in the art.

In another example of monitoring for an event, the receiving unit 105 can receive a termination message from the first network 110. For example, the termination message can be a control message that indicates termination of the audio call, such as the well known “Bye” message used in Session Initiation Protocol (SIP). In addition, the receiving unit 105 can fail to detect audio content on the first network 110. For example, the transceiver 152 of the receiving unit 105 can be operable to receive a wireless signal at a predetermined time, and the processor 150 can be operable to extract data from the wireless signal. The wireless signal can contain information such as the well known Cyclic Redundancy Check (CRC) which can indicate the presence of bit errors in the wireless signal. The processor 150 can determine the presence or absence of audio content on the first network based on results of one or more CRC indications.

In another example of monitoring for an event, the receiving unit 105 can lose association with the first network 110. As an example, it is well known in the Wi-Fi protocol that a receiving unit can be associated with a network after a set of procedures has successfully occurred, which can include synchronization and authentication. Once a receiving unit is associated with a network, the receiving unit and the network are capable of exchanging signals with one another, such as voice or data signals. The receiving unit and the network can maintain association by periodically exchanging probe signals, such as the well known probe request or probe response. For example, the receiving unit can transmit a probe request for reception at the network, and if the network successfully receives the probe request, it can transmit a probe response for reception at the receiving unit. If the receiving unit does not successfully receive a probe response after sending a probe request, it can determine that association has been lost. The receiving unit can further repeat the process of transmitting a probe request and attempting to receive a probe response one or more times, and can make a better decision on whether or not association has been lost.

The receiving unit 105 can detect one or more events, such as the events previously described, which can cause the receiving unit 105 to switch an audio path from the first network 110 to the second network 120. For example, the receiving unit 105 can designate an audio signal received from the first network 110 as a source of audio content for audible playout through the user interface 158. Switching the audio path can include designating an audio signal received from the second network 120 as the source of audio content for audible playout through the user interface 158.

For example, the first network 110 can be a Wi-Fi network, and the second network 120 can be a CDMA network. The receiving unit 105 can switch the audio path from the Wi-Fi network to the CDMA network in response to detection of the following events—(1) reception of a termination message from the Wi-Fi network, such as the “Bye” message used in the SIP protocol; (2) loss of association with the Wi-Fi network; or (3) reception of audio content on the CDMA network and failure to receive audio content on the Wi-Fi network during a window of time.

As noted above, the determination to switch the audio path can be contingent on the detection of both the failure to receive audio content on the Wi-Fi network and the reception of audio content on the CDMA network. As a more particular example, the receiving unit 105 may first detect the failure to receive audio content on the Wi-Fi network and may subsequently receive audio content on the CDMA network during a window of time, which can prompt the switching of the audio path. The window of time, for example, can begin before, upon, or after detection of the reception of audio content on the CDMA network and can terminate after a predetermined amount of time. The window of time can also be of length zero, in which the receiving unit 105 only monitors for the failure to receive audio content at single instantaneous time.

As another example, the receiving unit 105 may first detect reception of audio content on the CDMA network followed by the failure to receive audio content on the Wi-Fi network during a window of time, which can trigger the audio switch. As such, the order in which these two events occur is irrelevant for purposes of determining when to switch the audio path, and these events may even be detected simultaneously. In fact, if desired, only a single one of these events—failure to receive audio content on the Wi-Fi network or reception of CDMA audio content—can be used to cause the switch.

Optionally, the receiving unit 105 can maintain the audio path from the Wi-Fi network based on detecting audio content on the CDMA network and also detecting audio content on the Wi-Fi network during a window of time, such as the window of time described above. This process may maintain the Wi-Fi connection, as it may be desirable to do so based on certain criteria, such as calling expenses or available bandwidth. Additionally, the receiving unit 105 can maintain the audio path from the Wi-Fi network in response to failing to receive audio content on the Wi-Fi network during a window of time and also failing to detect audio content on the CDMA network, in which the window of time can be as described above.

In another example, the first network 110 can be a CDMA network, and the second network 120 can be a Wi-Fi network. In this arrangement, the receiving unit 105 can switch the audio path from the CDMA network to the Wi-Fi network simply in response to detection of audio content on the Wi-Fi network. It is understood, however, that the receiving unit 105 may switch from the CDMA network to the Wi-Fi network based on other suitable detected events, including those examples listed above in relation to the first network 110 being a Wi-Fi network and the second network 120 being a CDMA network.

It will be clear to one skilled in the art that there may be other suitable events that would lead to the switching of the audio path and the scope of the claims is not necessarily limited to any particular event(s). Moreover, any suitable combination of the events described above or any other events within the scope of the claims may be used to trigger the switching of the audio path.

While the various embodiments of the present invention have been illustrated and described, it will be clear that the claimed subject matter is not so limited. Numerous modifications, changes, variations, substitutions and equivalents will occur to those skilled in the art without departing from the spirit and scope of the present invention as defined by the appended claims.

What is claimed is:

1. A method of controlling an audio switch at a receiving unit during handoff, comprising:
at a receiving unit with an audio call active on a first network supporting a first audio protocol, setting up a second audio call on a second network supporting a different audio protocol;
monitoring for one or more events;
detecting one or more of the events; and
in response to the detection of one or more of the events, switching an audio path of the receiving unit from the first network to the second network.

2. The method according to claim 1, wherein one of the events comprises receiving at the receiving unit a termination message from the first network.

3. The method according to claim 1, wherein one of the events comprises the receiving unit detecting audio content on the second network.

4. The method according to claim 1, wherein one of the events comprises the receiving unit not detecting audio content on the first network.

5. The method according to claim 1, wherein one of the events comprises the receiving unit losing association with the first network.

6. The method according to claim 5, wherein losing association comprises the receiving unit not receiving a probe signal from the first network during a window of time.

7. The method according to claim 1, wherein the first network is a Wireless Fidelity (Wi-Fi) network and the second network is a Code Division Multiple Access (CDMA) network.

8. The method according to claim 1, wherein the first network is a CDMA network and the second network is a Wi-Fi network.

9. A receiving unit capable of controlling an audio switch during handoff, comprising:
a transceiver that is capable of receiving wireless signals from a first network and a second, different network;
a processor coupled to the transceiver, wherein the processor is operable to:
support an audio call on the first network wherein the first network supports a first audio protocol;
set up another audio call on the second network wherein the second network supports a different audio protocol;
monitor for one or more events;
detect one or more of the events; and
in response to the detection of one or more of the events, perform an audio switch to enable the receiving unit to handoff from the first network to the second network.

10. The receiving unit according to claim 9, wherein one of the events comprises receiving at the receiving unit a termination message from the first network.

11. The receiving unit according to claim 9, wherein one of the events comprises the receiving unit detecting audio content on the second network.

12. The receiving unit according to claim 9, wherein one of the events comprises the receiving unit not detecting audio content on the first network.

13. The receiving unit according to claim 9, wherein one of the events comprises the receiving unit losing association with the first network.

14. The receiving unit according to claim 13, wherein losing association comprises the receiving unit not receiving a probe signal from the first network during a window of time.

15. The receiving unit according to claim 9, wherein the first network is a Wi-Fi network and the second network is a CDMA network.

16. The receiving unit according to claim 9, wherein the first network is a CDMA network and the second network is a Wi-Fi network.

17. A machine readable storage device, having stored thereon a computer program having a plurality of code sections executable by a portable receiving device for causing the receiving device to perform the steps of:
activating an audio call on a first network supporting a first audio protocol;
setting up a second audio call on a second network supporting a different audio protocol;
monitoring for one or more events;
detecting one or more of the events; and
in response to the detection of one or more of the events, switching an audio path of the receiving device from the first network to the second network.

18. The storage device according to claim 17, wherein one of the events comprises receiving at the receiving device a termination message from the first network.

19. The storage device according to claim 17, wherein one of the events comprises the receiving device detecting audio content on the second network.

20. The storage device according to claim 17, wherein one of the events further comprises the receiving device not detecting audio content on the first network.

21. The storage device according to claim 17, wherein one of the events comprises the receiving device losing association with the first network.
